(19) United States
(12) Patent Application Publication
(10) Pub. No.: US 2025/0140927 A1
(43) Pub. Date: May 1, 2025

(54) Non-Aqueous Battery

(71) Applicant: TOYOTA JIDOSHA KABUSHIKI KAISHA, Toyota-shi Aichi-ken (JP)

(72) Inventor: Masato KAMIYA, Toyota-shi Aichi-ken (JP)

(73) Assignee: TOYOTA JIDOSHA KABUSHIKI KAISHA, Toyota-shi Aichi-ken (JP)

(21) Appl. No.: 18/892,702

(22) Filed: Sep. 23, 2024

(30) Foreign Application Priority Data
Oct. 27, 2023 (JP) 2023-184508

(51) Int. Cl. H01M 10/0568; H01M 10/0587; H01M 50/103; H01M 50/553; H01M 50/627

(52) U.S. Cl. CPC H01M 10/0568; H01M 10/0587; H01M 50/103; H01M 50/553; H01M 50/627; H01M 2300/0025

(57) ABSTRACT

A non-aqueous battery includes a case, an electrode assembly, and an electrolyte solution. The case has a width direction, a height direction, and a thickness direction. The case includes a first side wall and a second side wall. The second side wall faces the first side wall. Each of the first side wall and the second side wall is orthogonal to the width direction. A positive electrode terminal and a negative electrode terminal are provided at the first side wall. The electrode assembly is of a wound type. A winding axis of the electrode assembly is parallel to the width direction. The electrode assembly includes a first end portion and a second end portion. The first end portion faces the first side wall. A relationship of “R1/R2>1” is satisfied. R1 represents an electrode resistance at the first end portion. R2 represents an electrode resistance at the second end portion.

### CROSS REFERENCE TO RELATED APPLICATIONS

This nonprovisional application is based on Japanese Patent Application No. 2023-184508 filed on Oct. 27, 2023 with the Japan Patent Office, the entire contents of which are hereby incorporated by reference.

### BACKGROUND

### Field

The present disclosure relates to a non-aqueous battery.

### Description of the Background Art

Japanese Patent Laying-Open No. 2014-099365 discloses an electrode wound body.

### SUMMARY

A “side terminal structure” has been reviewed. In the side terminal structure, a case has a prismatic shape (rectangular parallelepiped shape). The case (rectangular parallelepiped) has a width direction, a height direction, and a thickness direction. Of the six surfaces of the rectangular parallelepiped, two surfaces orthogonal to the width direction are regarded as side surfaces. A wall including a side surface is a side wall. Both a positive electrode terminal and a negative electrode terminal are disposed at one of the two side walls. An electrode assembly is housed in the case such that a winding axis of the electrode assembly is parallel to the width direction. In the side terminal structure, there is a possibility that current concentration occurs at a portion of the electrode assembly in the vicinity of a terminal to result in progress of local deterioration.

An object of the present disclosure is to reduce current concentration in the vicinity of a terminal in a side terminal structure.

1. A non-aqueous battery includes a case, an electrode assembly, and an electrolyte solution. The case houses the electrode assembly and the electrolyte solution. The case has a rectangular parallelepiped outer shape. The case has a width direction, a height direction, and a thickness direction. The width direction, the height direction, and the thickness direction are orthogonal to one another. The case includes a first side wall and a second side wall. The second side wall faces the first side wall. Each of the first side wall and the second side wall is orthogonal to the width direction. A positive electrode terminal and a negative electrode terminal are provided at the first side wall. The electrode assembly is of a wound type. A winding axis of the electrode assembly is parallel to the width direction. The electrode assembly includes a first end portion and a second end portion. The first end portion is disposed at one end in the width direction. The second end portion is disposed at the other end in the width direction. The first end portion faces the first side wall. The non-aqueous battery satisfies a relationship of the following formula (1):

$$R 1 / R 2 > 1 , \qquad ( 1 )$$

In the formula (1), R1 represents an electrode resistance at the first end portion. R2 represents an electrode resistance at the second end portion.

Since the electrode resistance on the side (second end portion) opposite to the vicinity of the terminal (first end portion) is reduced as compared with that in the vicinity of the terminal, it is expected to reduce current concentration in the vicinity of the terminal.

2. The non-aqueous battery according to “1” may include, for example, the following configuration. The case has an aspect ratio of 2.9 or more. The aspect ratio represents a ratio of a dimension in the width direction to a dimension in the height direction.

Conventionally, when the aspect ratio is 2.9 or more in the side terminal structure, current concentration in the vicinity of the terminal is significant. The technology of “1” is suitable when the aspect ratio is 2.9 or more.

3. The non-aqueous battery according to “1” or “2” may include, for example, the following configuration. In the width direction, the electrode assembly has a dimension of 20 to 80 cm.

4. The non-aqueous battery according to any one of “1” to “3” may include, for example, the following configuration. An injection port is provided in the second side wall. The electrolyte solution includes a component that is able to reduce an electrode resistance.

The electrolyte solution can include various additives. The electrolyte solution may include, for example, a component that is able to reduce the electrode resistance. For example, when the injection port is provided in the first side wall, functions of the additives tend to be large at the first end portion close to the injection port. This is presumably because the electrolyte solution is likely to stagnate in the vicinity of the injection port when injecting the electrolyte solution. When the electrode resistance at the first end portion is reduced, current concentration at the first end portion may be promoted. On the other hand, when the injection port is disposed in the second side wall, the functions of the additives are expected to be large at the second end portion. As a result, the value of “R1/R2” in “1” is expected to be large. That is, it is expected to reduce current concentration at the first end portion.

5. The non-aqueous battery according to “4” may include, for example, the following configuration. The component that is able to reduce an electrode resistance include lithium bis(oxalate) borate (LiBOB).

Hereinafter, an embodiment of the present disclosure (hereinafter, also simply referred to as “the present example”) and an example of the present disclosure (hereinafter, also simply referred to as “the present embodiment”) will be described. It should be noted that the present embodiment and the present example do not limit the technical scope of the present disclosure. The present embodiment and the present example are illustrative in any respect. The present embodiment and the present example are non-restrictive. The technical scope of the present disclosure includes any modifications within the scope and meaning equivalent to the terms of the claims. For example, it is initially expected to extract freely configurations from the present embodiment and combine them freely.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic cross-sectional view showing an example of a non-aqueous battery according to the present embodiment.

FIG. 2 is a schematic view showing an example of a case according to the present embodiment.

FIG. 3 is a schematic view showing an example of an electrode assembly in the present embodiment.

FIG. 4 is a schematic plan view showing an example of an electrode and a separator in the present embodiment.

FIG. 5 is a table showing experimental results.

### DESCRIPTION OF THE EMBODIMENTS

### Terms

The “non-aqueous battery” contains an organic electrolyte solution. The non-aqueous battery may be, for example, a lithium ion battery.

The “electrode resistance” may be referred to as a local resistance. The electrode resistance indicates a value measured by the following method. The SOC (State Of Charge) of the non-aqueous battery is adjusted to 0%. When the non-aqueous battery is disassembled, the electrode assembly is recovered. The electrode assembly is disassembled. The positive electrode piece and the negative electrode piece are collected from the target portions (the first end portion and the second end portion) of the electrode assembly by punching. Each of the positive electrode piece and the negative electrode piece has a disk shape. Each of the positive electrode piece and the negative electrode piece has a diameter of 10 mm. A stack is formed by laminating the positive electrode piece, the separator, and the negative electrode piece. The stack and the electrolyte solution are sealed in a coin-shaped exterior package, whereby a coin cell is manufactured. The internal resistance of the coin cell is the electrode resistance. The internal resistance is measured by a resistance measuring device. A resistance measuring device having a measurement range suitable for the internal resistance of the coin cell is selected. The separator of the coin cell may be, for example, a product having the same specification as that of the separator of the electrode assembly. The electrolyte solution of the coin cell has any composition. For example, it may have the following composition.
Solvent: EC/EMC/DMC=1/1/1 (volume ratio)
Supporting electrolyte: LiPF₆ (1 mol/L)
Additives: no

The formal name of the abbreviation “EC” or the like will be described later.

The “width” indicates a dimension in the width direction. The “height” indicates the dimension in the height direction. The “thickness” indicates a dimension in the thickness direction.

Geometric terms are not to be construed in a strict sense. Examples of geometric terms include “parallel”, “perpendicular”, and “orthogonal”. For example, “parallel” may deviate somewhat from “parallel” in a strict sense. Geometric terms may include, for example, design, work, manufacturing tolerances, errors, etc. The dimensional relationship in each drawing may not coincide with the actual dimensional relationship. For example, the dimensional relationships in the figures may be varied to assist the reader's understanding. For example, the length, width, thickness, and the like may be changed. Some components may be omitted.

Numerical ranges such as “m to n %” include upper and lower limits unless otherwise specified. That is, “m to n %” indicates a numerical range of “m % or more and n % or less”. The “m % or more and n % or less” includes “more than m % and less than n %”. The expressions “or more” and “or less” are represented by an inequality sign “≤” with an equal sign. The expressions “more than” and “less than” are represented by an inequality sign “<” that does not include an equal sign. A numerical value freely selected from the numerical range may be set as a new upper limit value or lower limit value. For example, a new numerical value range may be set by freely combining a numerical value within the numerical value range with a numerical value described in another part, a table, a drawing, or the like in the present specification.

### —Non-Aqueous Battery—

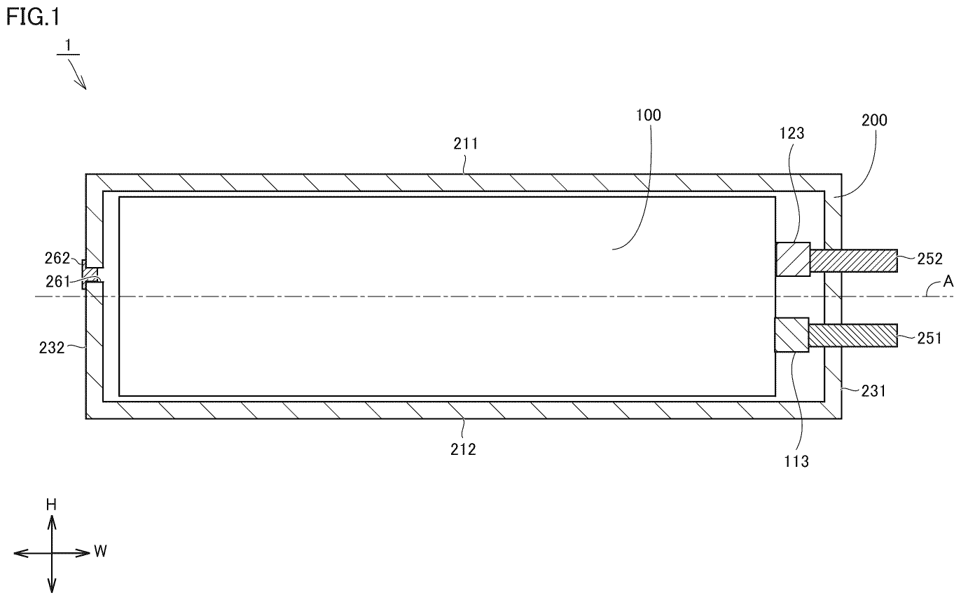

FIG. 1 is a schematic cross-sectional view showing an example of a non-aqueous battery according to the present embodiment. The battery 1 is a non-aqueous battery. The battery 1 includes a case 200, an electrode assembly 100, and an electrolyte solution (not shown). The case 200 houses the electrode assembly 100 and the electrolyte solution.

### —Case—

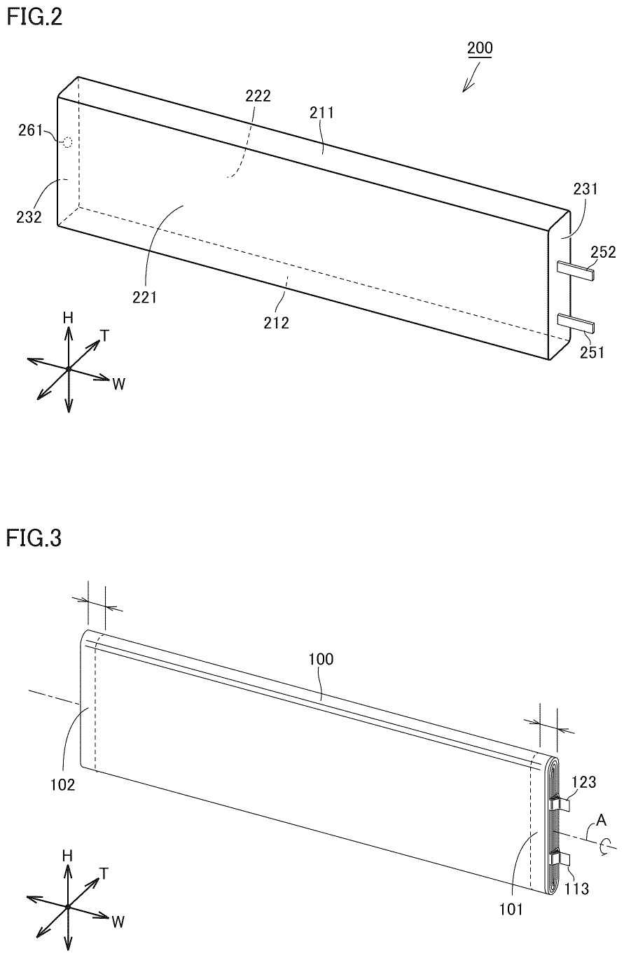

FIG. 2 is a schematic view showing an example of a case according to the present embodiment. The case 200 has a prismatic shape. That is, the case 200 has a rectangular parallelepiped outer shape. The corners of the case 200 may be rounded. The case 200 has a width (W) direction, a height (H) direction, and a thickness (T) direction. The W direction, the H direction, and the T direction are orthogonal to each other. The H direction may be parallel to the vertical direction, for example. The W direction may be parallel to the horizontal direction, for example. The T direction may be parallel to the horizontal direction, for example. The width may be greater than the height and thickness, for example. The thickness may be small relative to width and height, for example. For example, the relationship of “thickness≤height<width” may be satisfied. The case 200 may have an aspect ratio (width/height) of, for example, 2.9 or more. The aspect ratio of the case 200 may be, for example, 5 or more. The aspect ratio of the case 200 may be, for example, 2.9 to 5.

The case 200 may be made of metal, for example. The case 200 may include, for example, pure Al, an Al alloy, or the like. The case 200 includes a first bottom wall 211, a second bottom wall 212, a first main wall 221, a second main wall 222, a first side wall 231, and a second side wall 232. Each of the first bottom wall 211 and the second bottom wall 212 is orthogonal to the H direction. The first bottom wall 211 faces the second bottom wall 212. Each of the first main wall 221 and the second main wall 222 is orthogonal to the T direction. The first main wall 221 faces the second main wall 222. The first main wall 221 (second main wall 222) has a larger area than the first bottom wall 211 (second bottom wall 212) and the first side wall 231 (second side wall 232).

Each of the first side wall 231 and the second side wall 232 is orthogonal to the W direction. The first side wall 231 faces the second side wall 232. That is, the first side wall 231 is disposed at one end in the W direction. The second side wall 232 is disposed at the other end in the W direction. A positive electrode terminal 251 and a negative electrode terminal 252 are provided at the first side wall 231.

For example, the second side wall 232 may be provided with the injection port 261. The electrolyte solution may be injected into the case 200 through the injection port 261. The injection port 261 may be closed by, for example, a sealing plug 262 (see FIG. 1).

### —Electrode Assembly—

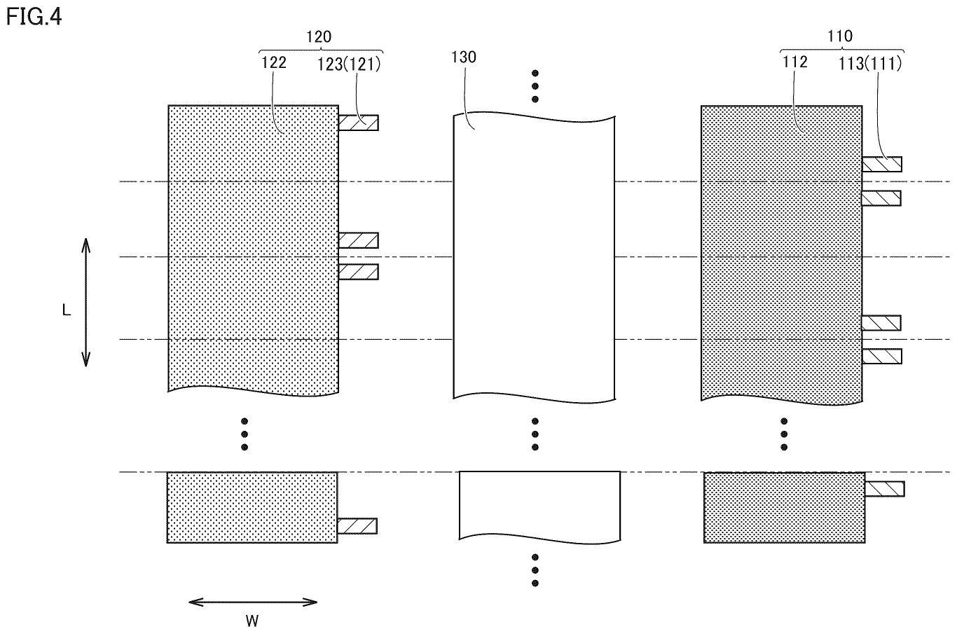

FIG. 3 is a schematic view showing an example of an electrode assembly in the present embodiment. FIG. 4 is a schematic plan view showing an example of an electrode and a separator in the present embodiment. The electrode assembly 100 is of a wound type. The electrode assembly 100 includes a positive electrode 110, a negative electrode 120, and a separator 130. Each of the positive electrode 110, the negative electrode 120, and the separator 130 is a strip-shaped sheet. The electrode assembly 100 may include two or more separators. For example, a stack is formed by stacking the positive electrode 110, the separator 130, the negative electrode 120, and the separator 130 in this order. The electrode assembly 100 can be formed by spirally winding the stack around the winding axis A. It may be wound clockwise or counterclockwise about the winding axis A. After the winding, the electrode assembly 100 may be formed into a flat shape. In the case 200, the winding axis A of the electrode assembly 100 is parallel to the W direction.

The electrode assembly 100 may have, for example, an aspect ratio of 2.9 or more. The aspect ratio of the electrode assembly 100 may be, for example, 5 or more. The aspect ratio of the electrode assembly 100 may be, for example, 2.9 to 5. The electrode assembly 100 may have a width of, for example, 20 to 80 cm.

The electrode assembly 100 may include a positive electrode tab 113 and a negative electrode tab 123. The positive electrode tab 113 is connected to the positive electrode terminal 251. The negative electrode tab 123 is connected to the negative electrode terminal 252 (see FIG. 1).

### —First End Portion and Second End Portion—

The electrode assembly 100 includes a first end portion 101 and a second end portion 102. Side surfaces of the electrodes are exposed at the first end portion 101 and the second end portion 102. The first end portion 101 and the second end portion 102 may be referred to as, for example, a “first open end portion” and a “second open end portion”.

The first end portion 101 is disposed at one end in the W direction. The first end portion 101 faces the first side wall 231. The first end portion 101 is close to the positive electrode terminal 251 and the negative electrode terminal 252. The positive electrode tab 113 and the negative electrode tab 123 may be disposed at the first end portion 101. The second end portion 102 is disposed at the other end in the W direction. The second end portion 102 is disposed on the opposite side of the first end portion 101 in the W direction. The second end portion 102 faces the second side wall 232. The second end portion 102 may face the injection port 261.

The first end portion 101 may be in a range of up to 5 cm inward from the end of the electrode assembly 100 in the W direction, for example. The second end portion 102 may be in a range of up to 5 cm inward from the end of the electrode assembly 100 in the W direction, for example.

The first end portion 101 has a first electrode resistance (R1). The second end portion 102 has a second electrode resistance (R2). The resistance ratio (R1/R2) is more than 1. That is, the following formula (1) is satisfied.

$$R 1 / R 2 > 1 \qquad ( 1 )$$

When the resistance ratio is more than 1, current concentration at the first end portion 101 can be relaxed. The resistance ratio may be, for example, 1.01 or more, 1.05 or more, 1.09 or more, 1.10 or more, or 1.12 or more. The resistance ratio may be, for example, 1.20 or less, 1.12 or less, 1.10 or less, or 1.09 or less.

### —Positive Electrode—

A two-dot chain line in FIG. 4 indicates a corner portion of the electrode assembly 100. The positive electrode 110 includes a positive electrode current collector 111 and a positive electrode active material layer 112. The positive electrode current collector 111 may include, for example, an Al foil or the like. Part of the positive electrode current collector 111 may be processed into the positive electrode tab 113. The positive electrode tab 113 may be bonded to the positive electrode current collector 111. The positive electrode tab 113 is disposed on one side in the W direction. A plurality of positive electrode tabs 113 may be provided. The positive electrode 110 is wound along the length (L) direction. The plurality of positive electrode tabs 113 are disposed so as to overlap each other in the T direction after winding (the electrode assembly 100).

The positive electrode active material layer 112 is disposed on the surface of the positive electrode current collector 111. The positive electrode active material layer 112 contains a positive electrode active material. The positive electrode active material may include, for example, at least one selected from the group consisting of LiCoO₂, LiNiO₂, LiMnO₂, LiMn₂O₄, Li(NiCoMn)O₂, Li(NiCoAl)O₂, and LiFePO₄. For example, “(NiCoMn)” in “Li(NiCoMn)O₂” indicates that the total composition ratio in parentheses is 1. The amount of individual components is freely set as long as the total is 1. Li(NiCoMn)O₂ may contain, for example, Li(Ni_{1/3}Co_{1/3}Mn_{1/3}) O₂, Li(Ni_{0.5}Co_{0.2}Mn_{0.3})O₂, Li(Ni_{0.8}Co_{0.1}Mn_{0.1}) O₂, or the like.

The positive electrode active material layer 112 may further include a conductive material and a binder. The conductive material may include, for example, at least one selected from the group consisting of carbon black, vapor-grown carbon fibers, carbon nanotubes, and graphene flakes. The blending amount of the conductive material may be, for example, 0.1 to 10 parts by mass with respect to 100 parts by mass of the positive electrode active material. The same applies to the conductive material in the negative electrode active material layer 122 (described later).

The binder may include, for example, at least one selected from the group consisting of polyvinylidene difluoride (PVDF), polytetrafluoroethylene (PTFE), vinylidene difluoride-hexafluoropropylene copolymer (PVDF-HFP), styrene-butadiene rubber (SBR), carboxymethyl cellulose (CMC), polyimide (PI), polyamide-imide (PAI), and polyacrylic acid (PAA). The blending amount of the binder may be, for example, 0.1 to 10 parts by mass with respect to 100 parts by mass of the positive electrode active material. The same applies to the binder in the negative electrode active material layer 122 (described later).

### —Negative Electrode—

The negative electrode 120 includes a negative electrode current collector 121 and a negative electrode active material layer 122. The negative electrode current collector 121 may include, for example, a Cu foil or the like. A part of the negative electrode current collector 121 may be processed into the negative electrode tab 123. A negative electrode tab 123 may be bonded to the negative electrode current collector 121. The negative electrode tab 123 is disposed on one side in the W direction. A plurality of negative electrode tabs 123 may be provided. The negative electrode 120 is wound along the L direction. The plurality of negative electrode tabs 123 are disposed so as to overlap each other in the T direction in the electrode assembly 100. The negative electrode tab 123 and the positive electrode tab 113 are disposed such that the negative electrode tab 123 is separated from the positive electrode tab 113 in the H direction of the electrode assembly 100.

The negative electrode active material layer 122 is disposed on the surface of the negative electrode current collector 121. The negative electrode active material layer 122 includes a negative electrode active material. The negative electrode active material may contain, for example, at least one selected from the group consisting of graphite, soft carbon, hard carbon, silicon, silicon oxide, a silicon-based alloy, tin, tin oxide, a tin-based alloy, and Li₄Ti₅O₁₂. The negative electrode active material layer 122 may further include a conductive material and a binder.

### —Separator—

Separator 130 separates positive electrode 110 from negative electrode 120. The separator 130 is porous. Separator 130 may be made of, for example, polyolefin. The separator 130 may have a multilayer structure. Separator 130 may include, for example, a polypropylene (PP) layer or a polyethylene (PE) layer. The separator 130 may be formed by, for example, stacking a PP layer, a PE layer, and a PP layer in this order.

### —Electrolyte Solution—

The electrolyte solution is a liquid electrolyte. At least a part of the electrolyte solution is impregnated in the electrode assembly 100. The electrolyte solution includes a supporting electrolyte and a solvent. The concentration of the supporting electrolyte may be, for example, 0.5 to 2 mol/L. The supporting electrolyte may include at least one selected from the group consisting of LiPF₆, LiBF₄, and Li(FSO₂)₂N. The solvent may include at least one selected from the group consisting of ethylene carbonate (EC), propylene carbonate (PC), butylene carbonate (BC), ethyl methyl carbonate (EMC), dimethyl carbonate (DMC), and diethyl carbonate (DEC).

The electrolyte solution may further contain an additive. The amount of additive may be, for example, any of 0.1 to 5%, 0.1 to 3%, or 0.1 to 1% in mass fraction. The additive may have any function. The additive may contain, for example, a component that is able to reduce the electrode resistance. Examples of the component include LiBOB. That is, the electrolyte solution may contain LiBOB. The additive may contain a component other than LiBOB. The additive may include, for example, at least one selected from the group consisting of LiBOB, vinylene carbonate (VC), vinylethylene carbonate (VEC), 1,3-propane sultone (PS), cyclohexylbenzene (CHB), and tert-amylbenzene (TAB).

### Examples

### —Test Cells—

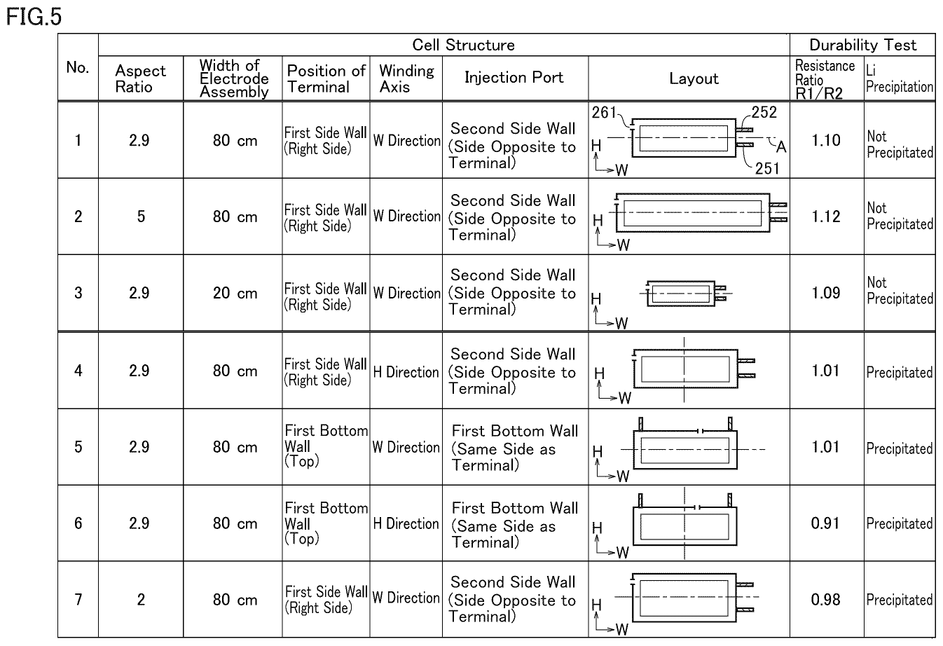

Test cells according to Nos. 1 to 7 were manufactured. FIG. 5 is a table showing experimental results. The structure of each test cell is shown in FIG. 5. In the item of “Layout” in FIG. 5, the positional relationship among the positive electrode terminal 251, the negative electrode terminal 252, the winding axis A, and the injection port 261 is simply shown. The test cells have a common material configuration. The material constitution is as follows.
Positive electrode active material: Li(NiCoMn) O₂
Negative electrode active material: natural graphite
Separator: three-layer structure (PP layer/PE layer/PP layer)
Electrolyte solution/solvent: EC/EMC/DMC=1/1/1 (volume ratio)
Electrolyte solution/supporting electrolyte: LiPF₆ (1 mol/L)
Electrolyte solution/additive: LiBOB (0.5%, mass fraction)

### —Durability Test—

Under a temperature environment of −30° C., constant current (CC) charging and constant current-constant voltage (CCCV) discharging under the following conditions were alternately repeated 100 times.

CC Charging: CC charging is performed from 3.0 V to 4.2 V with a current of 1 C.

CCCV discharge: CC discharge to 3.0 V is performed with a current of 1 C.

CV discharging is performed at 3.0 V.

“C” is a symbol indicating the time rate of the current. At a time rate of 1 C, the rated capacity of the battery is discharged in one hour.

After the durability test, the test cell was disassembled to recover the electrode assembly. Further, the electrode assembly was disassembled. The surface of the negative electrode included in the first end portion was visually observed. In the item of “Li Precipitation” in FIG. 5, “Precipitated” indicates that metallic gloss was confirmed by visual observation. In the same item, “Not Precipitated” indicates that no metallic gloss was confirmed. Further, the first electrode resistance (R1) at the first end portion and the second electrode resistance (R2) at the second end portion were measured.

### —Results—

No precipitation of Li was observed in No. 1 to No. 3. This is considered to be because the current concentration at the first end portion is relaxed. No. 1 to No. 3 satisfy all of the following conditions.

A positive electrode terminal and a negative electrode terminal are provided on the first side wall.

The winding axis of the electrode assembly is parallel to the W direction.

The relationship of “R1/R2>1” is satisfied.

In Nos. 4 to 7, precipitation of Li was confirmed. This is considered to be because current concentration occurs at the first end portion. No. 4 to No. 7 did not satisfy any one or more of the above conditions.

What is claimed is:

1. A non-aqueous battery comprising:
a case;
an electrode assembly; and
an electrolyte solution, wherein
the case houses the electrode assembly and the electrolyte solution,
the case has a rectangular parallelepiped outer shape,
the case has a width direction, a height direction, and a thickness direction,
the width direction, the height direction, and the thickness direction are orthogonal to one another,
the case includes a first side wall and a second side wall,
the second side wall faces the first side wall,
each of the first side wall and the second side wall is orthogonal to the width direction,
a positive electrode terminal and a negative electrode terminal are provided at the first side wall,
the electrode assembly is of a wound type,
a winding axis of the electrode assembly is parallel to the width direction,
the electrode assembly includes a first end portion and a second end portion,
the first end portion is disposed at one end in the width direction,
the second end portion is disposed at the other end in the width direction,
the first end portion faces the first side wall, and
the non-aqueous battery satisfies a relationship of the following formula (1):
R1/R2>1 (1), where
R1 represents an electrode resistance at the first end portion, and
R2 represents an electrode resistance at the second end portion.

2. The non-aqueous battery according to claim 1, wherein
the case has an aspect ratio of 2.9 or more, and
the aspect ratio represents a ratio of a dimension in the width direction to a dimension in the height direction.

3. The non-aqueous battery according to claim 1, wherein in the width direction, the electrode assembly has a dimension of 20 to 80 cm.

4. The non-aqueous battery according to claim 1, wherein
an injection port is provided in the second side wall, and
the electrolyte solution includes a component that is able to reduce an electrode resistance.

5. The non-aqueous battery according to claim 4, wherein the component that is able to reduce an electrode resistance includes lithium bis(oxalate) borate.
